(19) United States
(12) Patent Application Publication
(10) Pub. No.: US 2002/0113873 A1
(43) Pub. Date: Aug. 22, 2002

(54) Rear vision system for large vehicles

(76) Inventor: Michael R. Williams, Houston, TX (US)

Correspondence Address: Russell J. Egan, Suite 120, 908 Town & Country Blvd., Houston, TX, 77024-2221, US

(21) Appl. No.: 09/788,091

(22) Filed: Feb. 20, 2001

(51) Int. Cl. H04N 7/18

(52) U.S. Cl. 348/118; 348/148

(57) ABSTRACT

A system providing a real time display to the rear of a large vehicle having a normal blind spot to its rear has, as primary components, a display assembly mounted in close proximity to the driver for easy viewing by the driver, a camera assembly mounted at a top rear portion of the vehicle, and a control unit for controlling the several functions of the camera assembly including, but not limited to, focus the camera, changing the viewing angle, zooming in or out, turning on and off defogging/defrosting means, turning on and off wiper means, and raising and lowering a protective shield.

### BACKGROUND OF THE INVENTION

1. The Field of the Invention

The present invention relates to a system which enables the driver of a large vehicle, such as a truck or recreational vehicle, normally having obstructed vision to the rear of the vehicle, to observe on a real time basis what is happening to the rear of the vehicle while maintaining a normal forward facing driving posture.

2. The Prior Art

Large vehicles, such a trucks, trailers, tankers, vans, mobile homes, busses, etc. have a built in safety problem in that there are blind spots to the rear of the vehicle. Most of these vehicles have structure preventing the driver from seeing through the vehicles, as the driver can do in a conventional passenger car, thus creating the blind spot the size of which is largely dependant upon the vehicle type, size, and shape. The driver of such large vehicles have heretofore relied upon the use of side mounted mirrors to reduce these blind spots. But the use of side mounted mirrors still does not allow the driver to see what is directly behind the vehicle, especially when the driver is backing the vehicle. Also mirrors, because of their contoured surfaces, provide distorted images which can confuse a driver, particularly as to distances to and between objects. It is usually necessary for the driver of a large vehicle to have assistance, when backing, to assure that nothing will be run over and when the vehicle has reached the correct position, for example at a loading dock.

U.S. Pat. No. 6,115,651 to Cruz discloses system primarily intended for school busses to reveal the presence of an individual, in this instance a small child, closely adjacent the front or rear of the bus at a location not normally visible to the driver. The system has both front and rear units each having a plurality of sensors and a wide angle camera. The sensors include sound, motion and heat detectors all designed to sound an alarm when the sensed sound, motion or heat exceeds ambient background sound, motion or heat. If any one of the sensors detects the presence of someone in the blind area, an alarm is sounded and the driver alerted to check the monitor to ascertain the location of the individual. The system is active only when the vehicle is stopped and could be activated with conventional school bus warning lights.

U.S. Pat. No. 5,027,200 to Petrossian et al discloses a system which replaces conventional side mounted mirrors with a pair of video cameras each mounted on a respective side of the vehicle and being rearwardly directed. In the case of a tractor/trailer, a second pair of video cameras would be mounted on the trailer. This system is intended to replace conventional mirrors and obviate the distortion problems associated therewith. However, it does not solve the problem of viewing directly behind the vehicle and to this degree is little better than conventional mirrors.

U.S. Pat. No. 4,277,804 to Robison., in an effort to reduce the profile of a vehicle mounted video camera unit, mounts the camera perpendicular to the longitudinal axis of the vehicle and then uses light bending means to get light to the camera and to display the rear view from the vehicle. Means are also included to reverse the image for the driver's greater comprehension of the rear view.

U.S. Pat. No. 5,530,421 to Marshall et al discloses a video system for vehicles in which a plurality of cameras are mounted on the vehicle and selectively activated in accordance with vehicle performance. For example, if the vehicle turn signals are activated for a right turn, then the right side camera is activated also to display the right side blind spot. If the vehicle is placed in reverse, then the rearwardly directed camera will be activated and create a display of what is to the rear of the vehicle.

The present invention overcomes many of the rear blind spot problems discussed above by providing a video display which allows the driver to have a continuous, real time display of everything going on behind his large vehicle and to control the display.

### SUMMARY OF THE INVENTION

The present invention is a system providing a real time display to the rear of a large vehicle and has two primary components, namely a display assembly mounted in close proximity to the driver for easy viewing by the driver and a camera assembly mounted at a top rear portion of the vehicle. The display assembly has a camera assembly control unit for controlling the several functions of the camera assembly including, but not limited to, focus the camera, changing the viewing angle, zooming in or out, turning on and off defogging/defrosting means, turning on and off wiper means, and raising and lowering a protective shield.

### BRIEF DESCRIPTION OF THE DRAWINGS

The present invention will now be explained, by way of example, with reference to the accompanying drawings, in which:

FIG. 1 is a diagrammatic side view of a typical tractor/trailer showing the location of the components of the present invention;

FIG. 2 is a diagrammatic front view of the display assembly of the present invention with the monitor lowered from its housing for viewing;

FIG. 3 is a diagrammatic side elevation of the display assembly of the present invention with the monitor lowered from its housing to a viewing position;

FIG. 4 is a diagrammatic plan view of a control panel, possibly a remote unit, associated with the display assembly for controlling the camera assembly of the present invention;

FIG. 5 is a diagrammatic side elevation, partially in section, of the rear mounted camera assembly; and

FIG. 6 is a diagrammatic rear view of the camera assembly.

### DETAILED DESCRIPTION OF THE PRESENT INVENTION

Heretofore drivers have largely relied upon the use of side mounted mirrors to give them some idea of what is behind them. However, while side mounted mirrors may somewhat reduce the driver's blind spots along the sides of the vehicle, they do not allow viewing directly behind the vehicle. Thus there is the need for a rear viewing system which the present invention fills.

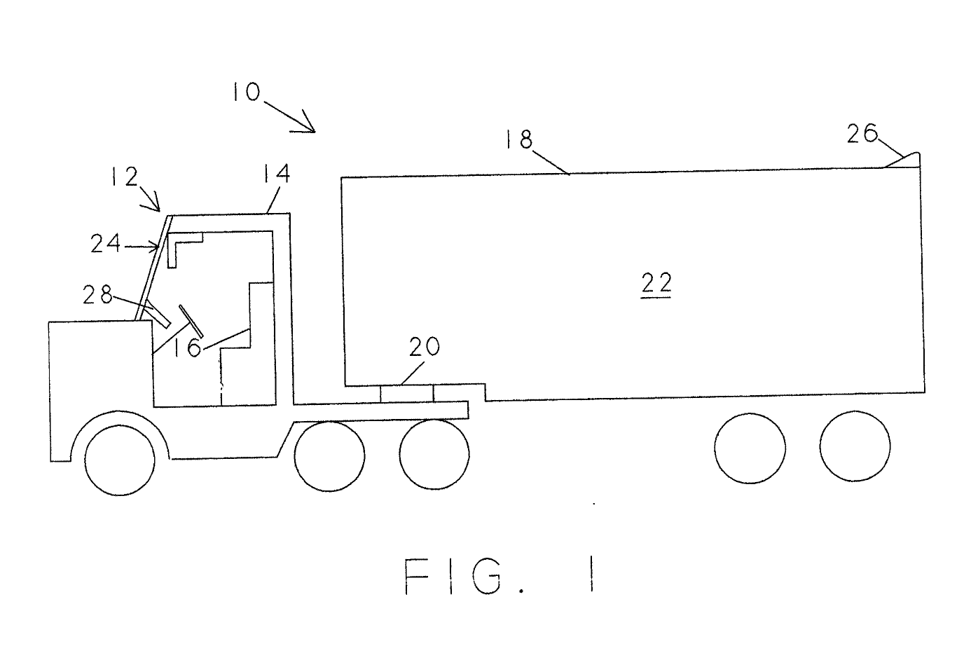

Turning now to FIG. 1, a tractor/trailer combination 10, usually referred to as an “eighteen wheeler,” includes a tractor 12 with a cab 14 to accommodate the driver (not shown) in seat 16 and the conventional controls for operating the vehicle. The tractor 12 is connected to a trailer 18 by a known pivotal connector 20. The trailer 18 has a cargo storage compartment 22, usually a large rectangular structure with one or more doors providing access to the interior of the compartment. The cargo compartment could also be a fluid containing tank, a replaceable cargo container, or simply an integral portion of a large truck or van. The compartment 22, regardless of its size or shape, obstructs the driver's view directly to the rear of the vehicle, which can be hazardous for the many reasons previously stated. The present invention has a cab mounted display assembly 24 and a camera assembly 26 mounted centrally on the upper rear edge of the trailer 18, or rear most upper edge of the cargo container. The present invention also has a control unit 28 which can be mounted on the dashboard of the vehicle, as shown, mounted on the display assembly housing, or can be made as a hand held remote unit.

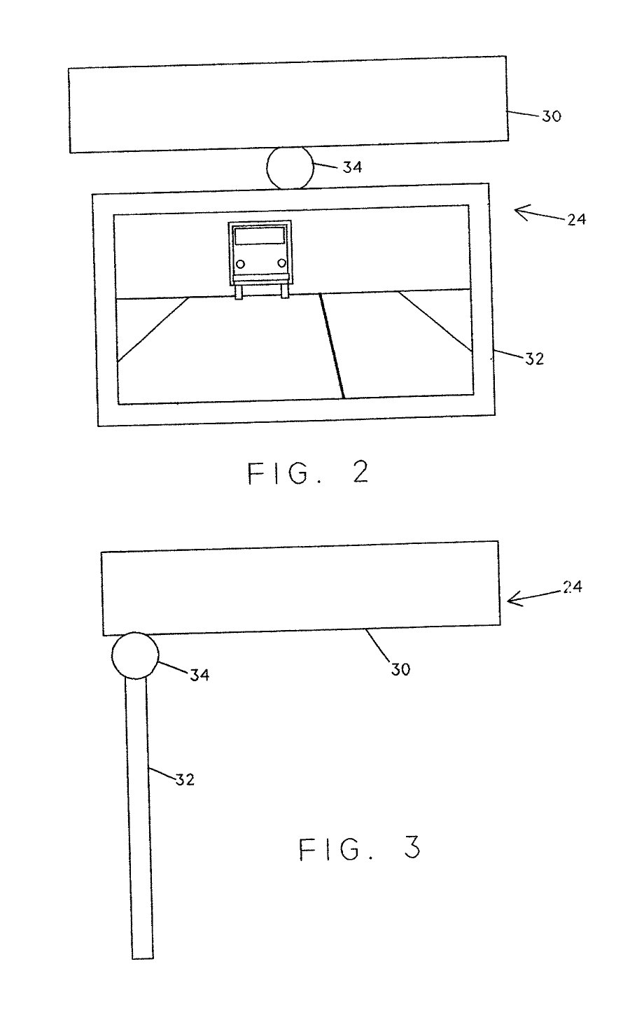

Turning now to FIGS. 2 to 4, the display assembly 24 has a housing 30 and a viewing monitor 32 mounted thereon by pivot means 34. The housing 30 preferably is mounted forwardly and horizontally against the roof liner of the cab in the location approximately where a rearview mirror is mounted in a conventional passenger car. The viewing monitor 32 is pivotally mounted in the housing 30 so as to allow movement of the viewing monitor 32 from a generally horizontal storage position (not shown) in which the monitor lies substantially fully within the housing 30 to a generally vertical position viewing position (as shown) depending from the housing. Preferably the monitor 32 is a liquid crystal display (LCD) having a thin overall profile. The pivot mounting means 34 allows for tilt and rotational movement of the monitor 32 for easily adjusting the viewing angle. The monitor screen will display, in real time, a view to the rear of the vehicle, a diagrammatically illustrated in FIG. 2.

It is within the scope of the present invention to have a number of features associated with the display assembly. For example, enabling activation of the monitor (including being capable of opening or lowering, which can be an automatically powered operation) only when the ignition of the vehicle is on and a single button is pressed by the driver, much in the same manner as headlights or wipers. The display monitor can also be automatically closed approximately 5 to 10 minutes after the vehicle ignition has been turned off and the ignition key removed, similar to delayed action headlights. The display monitor could also be raised and lowered in response to a keyless entry system and the alarm has been armed or turned off by the driver.

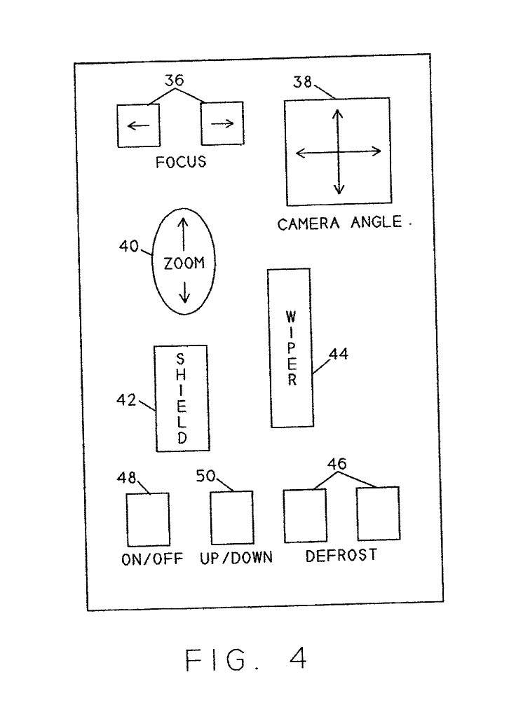

The control unit 28 can be mounted on the housing 30 (not shown), on the dashboard (as shown), steering wheel (not shown), or can be made as a handheld remote control unit. Only the face of the control panel 28 has been shown (see FIG. 4) and it includes controls for focusing the camera 36, changing camera angle 38 by panning from side-to-side and/or raising and lowering, zooming in and out 40, raising and lowering a camera shield 42, controlling a wiper 44, controlling a defrost/defogger 46, turning the system on and off 48, and raising and lowering the monitor 50. A handheld embodiment of the control unit would enable the driver to adjust the picture supplied by the digital camera with a minimum of distraction.

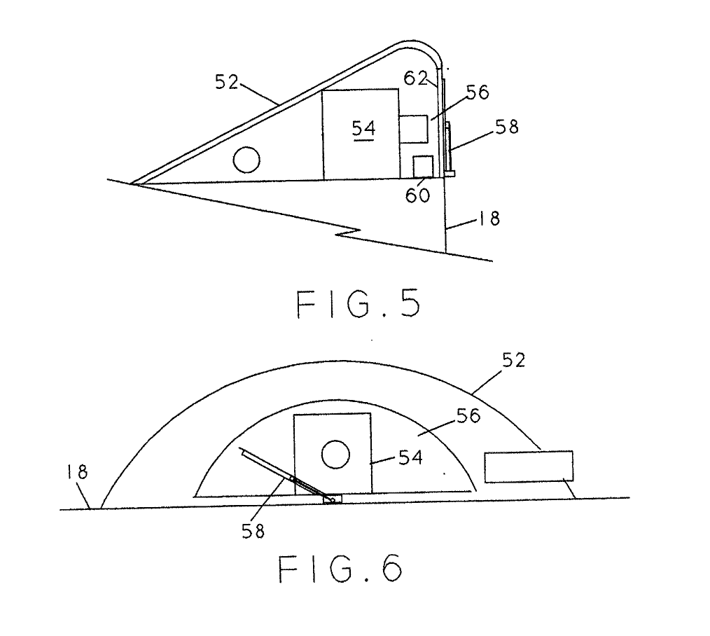

Turning now to FIGS. 5 and 6, the camera assembly 26 has a housing 52, which preferably is aerodynamically shaped, enclosing a video camera 54 directed toward a rearwardly facing viewing port 56 provided with wiper means 58, defogging means 60, and a transparent shield 62. The video camera 54 is preferably a digital camera of known type and includes a mother board (not shown) with connections for cables leading to the electrical system of the vehicle and to the display assembly and control unit within the truck cab. The shield 62 encloses the rear face of the camera housing 52, to protect the camera and its lens, and is preferably made of clear plastic, such as Lexan or Plexiglas. Both the wiper system and defrosting/defogging system serve to keep this protective shield clear for the camera. The camera assembly is connected to the vehicle power supply by cables (not shown) and could be connected into the vehicle lighting system. The same or additional cables would connect the camera assembly to both the control unit and the display assembly. Power for the camera assembly and data relay could be through the normal hookup between the tractor and trailer. However, it is within the scope of the present invention to include wireless communication between the camera assembly and the display assemble and control unit.

If a wireless communication embodiment is chosen, then such system could be incorporated into a wireless telephone system allowing the driver to communicate with the dispatcher and/or to call in road conditions and/or hazards.

The subject system replaces conventional rearview mirrors and allows the driver to clearly determine conditions behind a large vehicle on a real time basis, from the driver's seat, while the vehicle is in motion and without undo distraction from the job of driving. It will eliminate guesswork and low-speed accidents, when reversing into confined spaces, by providing a clear and unobstructed view to the immediate rear of a truck and/or trailer. The subject system has a fully automatic display assembly, which can readily be mounted for easy viewing by the driver in either new construction or as a retrofit upgrading of a vehicle. The camera assembly preferably uses a digital camera with an aerodynamically shaped housing mounted at the top rear edge of the vehicle or trailer, preferably in the center so it can view the area directly behind and to the rear of the vehicle and yet be little affected by road spray etc. This assembly can also be included with new construction or as a retrofit upgrading of a vehicle. In the latter case there would be the additional requirement of providing mounting means (ie. clamps not shown) to secure the camera assembly to the vehicle. It is within the scope of the invention that this mounting means could be a clamping assembly allowing the camera assembly to be detachably mounted on, for example, a shipping container which is likely to be stacked at some point during transit at which time the camera assembly would either be in the way of stacking or likely to be damaged by stacking. Such containers are regularly placed on special truck beds for local delivery after being mass moved between locations.

The camera assembly preferably includes a stabilizer system (not shown) to prevent unnecessary camera motion while the vehicle is traveling, which would adversely affect the display picture quality. Such a stabilizer system could include a combination of shock absorber means and gyroscopes (neither of which have been shown) to automatically counteract motion of the truck to provide a stable, reliable rear image for the driver.

On the highway, the subject invention enables the driver to be continuously aware of traffic conditions behind the truck and/or trailer while traveling. The driver need only glance up at the monitor for a clear, unobstructed view to the rear (much like glancing at a traditional rearview mirror).

The present invention can be installed as either aftermarket or new-production of tractor trailers, straight trucks, and many other large commercial vehicles and recreational vehicles which traditionally have been plagued by obstructed rear vision. The present invention fulfills a long felt need for a rear display system for large commercial vehicles and recreational vehicles. The appealing features of present invention include its automatic operation, easy of use, and the avoidance of accidents. Instead of being completely unaware of what is happening behind a large vehicle in motion, a display screen provides the driver with a clear rear view. This makes it easier to detect a tailgater, police, a speeding car approaching in an adjacent lane, or any other special situation of which the driver should be aware.

When reversing, such as when pulling into a loading dock, the camera provides a fill view to the immediate rear of the vehicle. This enables the driver to see where the vehicle is headed so that obstructions can be avoided and the vehicle or trailer can be precisely directed into the intended direction and location. It provides peace of mind for the driver and eliminates the stress and anxiety of reversing “blindly”. This helps in preventing costly accidents thereby keeping insurance costs down and improving the bottom line for trucking companies. It also eliminates the need for a second person to help guide a truck and/or trailer into position.

The present invention may be subject to many modifications and changes without departing from the spirit or essential characteristics thereof. The described embodiment should therefor be considered in all respects as illustrative and not restrictive as to the scope of the invention as defined by the appended claims.

I claim:

1. A system providing a real time display to the rear of a large vehicle having a normal blind spot to its rear, said system comprising:
a display assembly mounted in close proximity to the driver for easy viewing by the driver;
a camera assembly mounted at a top rear portion of the vehicle; and
a control unit for controlling the several functions of the camera assembly

2 The system according to claim 1 wherein said control unit focuses the camera.

3. The system according to claim 1 wherein said control unit changes the viewing angle of said camera.

4. The system according to claim 1 wherein said control unit controls zooming in and out of the camera

5. The system according to claim 1 further comprising:
defogging/defrosting means and said control unit controls turning on and off of said defogging/defrosting means,.

6 The system according to claim 1 further comprising:
wiper means and said control unit controls turning on and off said wiper means

7 The system according to claim 1 wherein said camera assembly further comprises:
a housing enclosing a camera and a protective shield through which said camera view to the rear of the vehicle and said control unit controls raising and lowering of said shield.

8. The system according to claim 1 wherein said display assembly comprises:
housing means mountable within a driver compartment of the vehicle within easy viewing distance of the driver; and
monitor means mounted on said housing for movement between a storage position within said housing ans a display position depending from said housing.

9. The system according to claim 1 wherein said system in tied into the ignition of the vehicle and enable only when the ignition is turned on.

10. The system according to claim 1 wherein said display assembly and said camera assembly are connected by electrical cables.

11. The system according to claim 1 wherein said display assembly and said camera assembly are in wireless communication.

12. The system according to claim 1 further comprising means to secure said camera assembly to an upper rear edge of a vehicle.

13. The system according to claim 1 wherein said camera assembly includes a digital camera.

14. The system according to claim 1 wherein said display assembly includes and LCD monitor.

15. The device providing rear viewing from a large vehicle thereby eleiminating blind spots, comprising
display means mounted in a driver compartment of said vehicle in a location readily viewable by the driver, said display means having a housing with a monitor mounted therein;
camera means having a protective housing enclosing a camera and providing rearwardly directed viewing;
means connecting said display means and said camera means providing power thereto and data exchange therebetween; and
control means controlling the functions of the camera.
